(19) United States
(12) Patent Application Publication
(10) Pub. No.: US 2014/0195902 A1
(43) Pub. Date: Jul. 10, 2014

(54) METHOD FOR MIXEDLY TYPESETTING MULTI-LANGUAGE TEXT

(71) Applicants: Beijing Founder Electronics Co., Ltd., Beijing (CN); Peking University Founder Group Co., Ltd., Beijing (CN)

(72) Inventors: Yanfei YANG, Beijing (CN); Yaojun TANG, Beijing (CN); Bin WANG, Beijing (CN); Changhua YAN, Beijing (CN); Ping MIAO, Beijing (CN)

(73) Assignees: Beijing Founder Electronics Co., Ltd., Beijing (CN); Peking University Founder Group Co., Ltd., Beijing (CN)

(21) Appl. No.: 14/098,406

(22) Filed: Dec. 5, 2013

(30) Foreign Application Priority Data
Jan. 9, 2013 (CN) 201310008307.1

(51) Int. Cl. G06F 17/27

(52) U.S. Cl. CPC G06F 17/27
USPC 715/264

(57) ABSTRACT

The present invention provides a method for mixedly typesetting multi-language text, comprising: acquiring a typesetting rule set (RS), a multi-language (ML), a multi-font (MF), and corresponding selected text; and performing language parsing according to the selected text and the corresponding typesetting RS, ML, and MF, and typesetting the selected text. By virtue of the method and apparatus for mixedly typesetting multi-language text according to the present invention, languages and fonts are automatically and quickly set for multi-language text to be mixedly typeset, and the text is correctly typeset according to typesetting rules according to the languages, thereby solving the problems that mixed typesetting of multi-language text in the prior art is complicated and time-consuming and labor-consuming, and has poor effect.

### FIELD OF THE INVENTION

The present invention relates to the field of typesetting technologies, and in particular to a method and apparatus for mixedly typesetting multi-language text.

### DESCRIPTION OF THE PRIOR ART

At present, in the field of computer processing, documents with multi-language text mixedly typeset need to be processed generally. As cross-language and cross-platform character code, Unicode has been put into large-scale application, which has become one of the most commonly used text character coding modes.

Although Unicode defines a uniform and unique binary code for each character, the same code is applied in Unicode if multiple sub-languages in the same language family have identical letters. For example, Arabic characters use a code interval of U0600-U06FF, but Uyghur characters also use this code interval; and traditional Mongolian characters use a code interval of 1800-18AF, but Todo Mongolian character also use this code interval, in this case, it is found in the process of mixedly typesetting multi-language text, that since sub-languages in the same language family use the same code interval, it is too challenging to determine an actual language of characters using a specific code during mixed typesetting of text in sub-languages belonging to the same language family,

Therefore, in a document in the Uniform format, an actual language property is generally defined for a specific part of text. Typesetters may select a paragraph in the text by dragging with the mouse or operating with the keyboard, and set a language property for the selected paragraph by using a menu command.

However, in an existing process of mixedly typesetting multi-language text, the inventors have found that the existing mixedly typesetting method has the following defects:

When the document for multi-language text mixed typesetting is too large, the typesetters need to manually set language properties for the entire document one by one, which causes burdensome workload, complicated operations, and low efficiency, if a new character is input or pasted into the document, a language property needs to be defined therefore; otherwise, errors may occur in typesetting. For example, a Uyghur word is input into a Chinese paragraph, a language property of Uyghur needs to be defined for this word; otherwise, this word may be recognized as an Arabic word by the system.

### SUMMARY OF THE INVENTION

The present invention is directed to providing a convenient and efficient solution for mixedly typesetting multi-language text, which is capable of automatically and quickly setting languages and fonts for multi-language text to be mixedly typeset, and correctly typesetting the text according to typesetting rules according to the languages, thereby solving the problems that mixed typesetting of multi-language text in the prior art is complicated and time-consuming and labor-consuming, and has poor effect.

In view of the defects in the prior art, embodiments of the present invention are directed to providing a method and apparatus for mixedly typesetting multi-language text.

An embodiment of the present invention provides a method for mixedly typesetting multi-language text, comprising:

acquiring a typesetting rule set (RS), a multi-language (ML), a multi-font (MF), and corresponding selected text; and

performing language parsing according to the selected text and the corresponding typesetting RS, ML, and MF, and typesetting the selected text.

An embodiment of the present invention provides an apparatus for mixedly typesetting multi-language text, comprising:

an information acquiring unit, configured to acquire a typesetting RS, an ML, an MF, and corresponding selected text; and

a typesetting unit, configured to perform language parsing according to the selected text and the corresponding typesetting RS, ML, and MF, and typeset the selected text.

According to the method and apparatus for mixedly typesetting multi-language text provided in the embodiments of the present invention, a typesetting RS, an ML, an MF, and corresponding selected text is automatically acquired; and language parsing is performed according to the selected text and the corresponding typesetting RS, ML, and MF, and typesetting the selected text, and the selected text is typeset. In this way, the process of mixedly typesetting multi-language text is convenient and efficiently. Furthermore, workload of typesetting personnel can be greatly reduced, thereby reducing typesetting error rate.

### BRIEF DESCRIPTION OF THE DRAWINGS

The present invention will be more clearly understood from the description of preferred embodiments as set forth below, with reference to the accompanying drawings, wherein:

FIG. 1 is a flowchart of a method for mixedly typesetting multi-language text according to an embodiment of the present invention;

FIG. 2 is a flowchart of specific implementation of step 102 in a method for mixedly typesetting multi-language text according to an embodiment of the present invention;

FIG. 3 is a flowchart of specific implementation of step 201 in a method for mixedly typesetting multi-language text according to an embodiment of the present invention;

FIG. 4 is a flowchart of specific implementation of step 302 according to an embodiment of the present invention;

FIG. 5 is a flowchart of specific implementation of step 203 according to an embodiment of the present invention; and

FIG. 6 is a schematic structural diagram of an apparatus for mixedly typesetting multi-language text according to an embodiment of the present invention.

### DETAILED DESCRIPTION OF THE PREFERRED EMBODIMENTS

A method and apparatus for mixedly typesetting multi-language text according to embodiments of the present invention are described in detail with reference to attached drawings and exemplary embodiments.

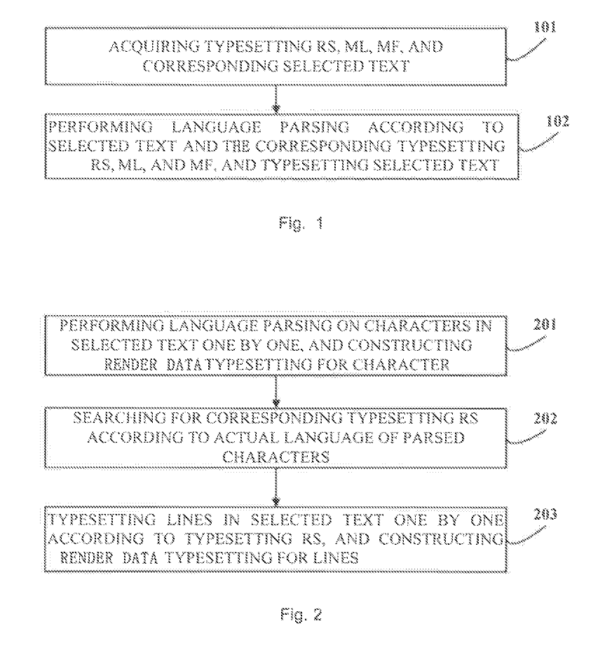

FIG. 1 illustrates a method for mixedly typesetting multi-language text according to an embodiment of the present invention. The method may comprise:

101: acquiring a typesetting RS, an ML, an MF, and corresponding selected text;

102: performing language parsing according to the selected text and the corresponding typesetting RS, ML, and MF, and typesetting the selected text.

It should be noted that the method may further comprise:
creating the typesetting RS, ML, and MF;
wherein the typesetting RS comprises: a language property, a punctuation forbidden property undo word break property, an automatic lengthening property, a vertical text rotation property; the ML comprises a primary language property and a N number of secondary language properties, N≧1; and the MF comprises at least one font item, wherein the font item comprises a language property and a font property.

In the typesetting RS, the language property refers to a text language corresponding to the typesetting rule; the punctuation forbidden property refers to that a part of punctuation marks in the language is forbidden for typesetting at the head or tail of a line; the word break property refers to automatically inserting a hyphen to control word break position, when a word or a phrase appears at the tail of a line; the automatic lengthening property refers to automatically inserting lengthening characters among, the words in the language to achieve take full occupancy in terms of the line format; and the vertical text rotation property refers to that the text in the language is automatically rotated by a specific angle for display in case of vertical typesetting.

The primary language property and the secondary language property in the ML refer to any languages supported by the system.

The MF comprises a plurality of font items; each font item comprises a language property and a font property; the language property refers to a text language corresponding to the MF; and the font property refers to a font name and a font style applied in text in such a language.

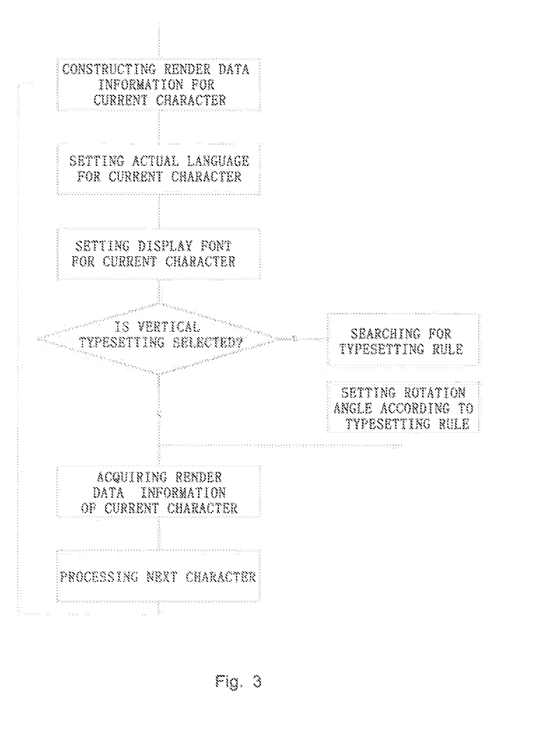

Based on step 102 described in the above embodiment, FIG. 2 illustrates a specific implementation process of step 102 in a method for mixedly typesetting multi-language text according to an embodiment of the present invention. The process specifically may include the following steps:

201; performing language parsing on characters in the selected text one by one, and constructing render data typesetting for the characters; wherein a process of constructing render data typesetting for the characters in this step is as illustrated in FIG. 3;

202: searching for a corresponding typesetting RS according to an actual language of the parsed characters; and

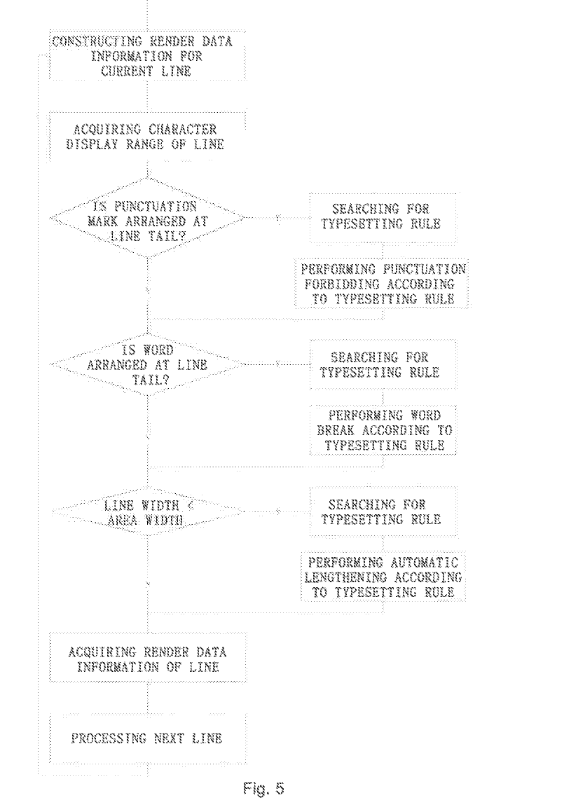

203: typesetting lines in the selected text one by one according to the typesetting RS, and constructing render data typesetting for the lines; wherein a flowchart of specific implementation of this step is as illustrated in FIG. 5.

FIG. 3 illustrates a specific implementation process of performing language parsing on characters in the selected text one by one, and constructing render data typesetting for the characters in a method for mixedly typesetting multi-language text according to an embodiment of the present invention. The process may include the following steps:

301: parsing a current character, and constructing render data information for the current character, wherein the render data information of the current character comprises: an actual language, a display font, and a rotation angle;

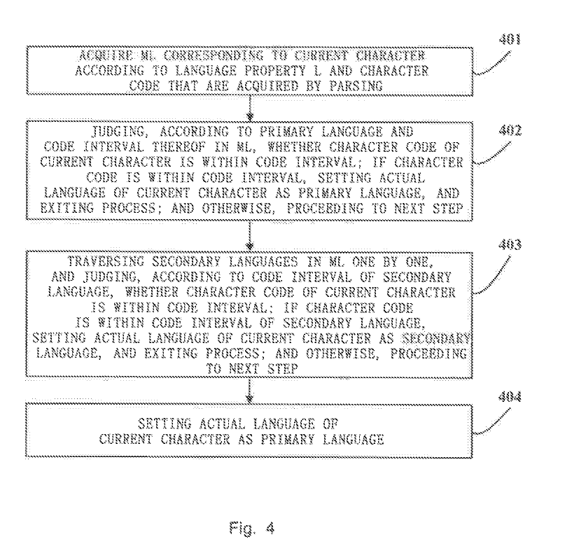

302: matching a language property L and a character code that are acquired by parsing with the ML, and setting a language property successfully matching the ML as the actual language of the current character; wherein a process of setting the language property successfully matching the ML as the actual language of the current character is as illustrated in FIG. 4;

303: searching in the MF for a corresponding font property according to the actual language of the current character, and setting a font property successfully matching the MF as the display font in a render data font information of the current character;

304: when vertical typesetting is set for the current character, searching in the typesetting RS for a corresponding typesetting rule according to the actual language of the current character, and setting a vertical text rotation angle successfully matching the typesetting rule in the typesetting RS as the rotation angle in the render data font information of the current character; and

305: acquiring the render data information of the current character, and continuing to construct the render data information for a next character until all characters are processed.

FIG. 4 illustrates a specific implementation process of step 302 according to an embodiment. The process may include the following steps:

401: acquiring an ML corresponding to the current character according to the language property L and the character code that are acquired by parsing;

402: judging according to a primary language and a code interval thereof in the ML, whether the character code of the current character is within the code interval: if the character code is within the code interval, setting the actual language of the current character as the primary language, and exiting the process; and otherwise, proceeding to a next step;

403: traversing secondary languages in the ML one by one, and judging, according to a code interval of the secondary language, whether the character code of the current character is within the code interval; if the character code is within the code interval of the secondary language, setting the actual language of the current character as the secondary language, and exiting the process; and otherwise, proceeding to a next step; and

404: setting the actual language of the current character as the primary language.

FIG. 5 illustrates a specific implementation process of step 203 according to an embodiment. The process may include the following steps:

501: performing language parsing on lines in the selected text one by one, and constructing render data information for a current line, wherein the render data information of the current line comprises: a character display range, a word break result, and an automatic lengthening result;

502: acquiring a character display range of a line according to a width of a line area that is acquired by parsing and a typesetting width between characters in the line within the line area;

503: if a punctuation mark is arranged at the tail of the current line, according to an actual language of the punctuation mark, searching in the typesetting RS for a corresponding typesetting rule; if a typesetting rule matching the punctuation mark is searched, processing the current line according to the punctuation forbidden property of the typesetting rule, removing a line tail-forbidden punctuation mark out of the character display range, and leaving a line head-forbidden punctuation mark within the character display range;

504: word is arranged at the tail of the current line, according to an actual language of the word, searching in the typesetting RS for a corresponding typesetting rule; if a typesetting rule matching the word is searched, processing the current line according to the typesetting rule, automatically inserting a hyphen, leaving letters before the hyphen within the character display range, and recording a word break result;

505: if a total character display width of the current line is smaller than the width of the line area, and no line stop character is arranged, traversing all words in the current line, according to an actual language of each of the words, searching in the typesetting RS for a corresponding typesetting rule if a typesetting rule matching the word is searched, according to automatic lengthening in the typesetting rule, automatically inserting a lengthening character, lengthening the width of the word such that the total character display width of the current line is equal to the width of the line area, and recording an automatic lengthening result; and

506: acquiring the render data information of the current line, and continuing to construct the render data information for a next line until all lines are processed.

In view of the above embodiment description, it is herein assumed that an article has five paragraphs. Paragraphs 1, 3, and 5 are Chinese paragraphs, paragraph 2 is an Arabic paragraph, and paragraph 4 is a Uyghur paragraph.

The typesetting RS is set as follows.

| | Punctuation | | Automatic | |
|---|---|---|---|---|
| Language | forbidden | Word Break | Lengthening | Vertical Rotation |
| Property | Property | Property | Property | Property |
| Chinese | Yes | No | No | No |
| Arabic | Yes | Yes | No | 90 degrees |
| | | | | counter-clockwise |
| Uyghur | Yes | Yes | Yes | 90 degrees |
| | | | | counter-clockwise |

An ML 1 is set, including Chinese (primary language), and Arabic. An ML 2 is set, including Chinese (primary language), and Uyghur.

The entire article is selected for application of the ML 2, and paragraph 2 is selected for application of the ML 1.

Based on the above assumption, by using the automatic typesetting processes according to Embodiments illustrated in FIG. 1 to FIG. 5, text mixed typesetting is achieved quickly and neatly according to requirements of text in various languages.

For example, the entire article is used as the selected text firstly; the system automatically acquires the selected text and a corresponding typesetting RS, ML 2, and MF, performs language parsing on the selected text according to the acquired information, and typesets the selected text.

After the entire article is typeset, the system further automatically acquires the selected text (paragraph 2) and a corresponding typesetting RS, ML 1, and MF, performs language parsing on the selected text (paragraph 2) according to the acquired information, and typesets the selected text (paragraph 2).

After paragraph 2 is typeset, the multi-language mixed typesetting for the entire article is completed.

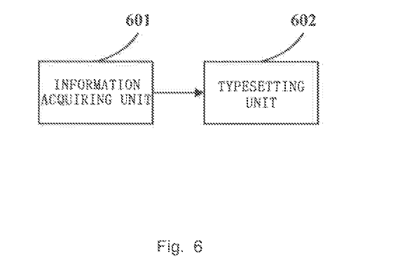

FIG. 6 illustrates an apparatus for mixedly typesetting multi-language text according to an embodiment of the present invention. The apparatus may comprise:
an information acquiring unit 601, configured to acquire a typesetting RS, an ML an MF, and corresponding selected text; and
a typesetting unit 602, configured to perform language parsing according to the selected text and the corresponding typesetting RS, ML, and MF, and typeset the selected text.

It should be noted that the apparatus may further comprise:
a rule creating unit, configured to create the typesetting RS, ML, and MF;
wherein the typesetting RS comprises: a language property, a punctuation forbidden property, and a word break property, an automatic lengthening property, a vertical text rotation property; the ML comprises a primary language property and a N number of secondary language properties, N≧1; and the MF comprises at least one font item, wherein the font item comprises a language property arid a font property.

It should be noted that the typesetting unit 602 may specifically comprise:
a character parsing subunit, configured to perform language parsing on characters in the selected text one by one, and construct render data typesetting for the characters;
a searching subunit, configured to search for a corresponding typesetting RS according to an actual language of the parsed characters; and
a line typesetting subunit, configured to typeset lines in the selected text one by one according to the typesetting RS, and construct render data typesetting for the lines.

It should be noted that the character parsing subunit may specifically comprise:
a character parsing sub-subunit, configured to parse a current character, and construct render data information for the current character, wherein the render data information of the current character comprises: an actual language, a display font, and a rotation angle;
a character matching sub-subunit, configured to match to a language property L and a character code that are acquired by parsing with the ML, and set a language property successfully matching the ML to the actual language of the current character;
a character setting sub-subunit, configured to: search in the MF for a corresponding font property according to the actual language of the current character, and set a font property successfully matching the MF as the display font in a render data font information of the current character; when vertical typesetting is set for the current character, search in the typesetting RS for a corresponding typesetting rule according to the actual language of the current character, and set a vertical text rotation angle successfully matching the typesetting rule in the typesetting RS as the rotation angle in the render data font information of the current character; and
a character constructing sub-subunit, configured to acquire the render data information of the current character, and continue to construct the render data information for a next character until all characters are processed.

It should be further noted that the character matching sub-subunit may be specifically configured to: acquire ML corresponding to the current character according to the language property L and the character code that are acquired by parsing; judge, according to a primary language and a code interval thereof in the ML, whether the character code of the current character is within the code interval; if the character code is within the code interval, set the actual language of the current character as the primary language, and exit the process; and otherwise, proceed to a next step; traverse secondary languages in the ML one by one, and judge, according to a code interval of the secondary language, whether the character code of the current character is within the code interval; if the character code is within the code interval of the secondary language, set the actual language of the current character as the secondary language, and exit the process; and otherwise, proceed to a next step; and set the actual language of the current character as the primary language.

It should be further noted that the line typesetting subunit may specifically comprise:
a line parsing sub-subunit, configured to perform language parsing on lines in the selected text one by one, and construct render data information for a current line, wherein the render data information of the current line comprises: a character display range, a word break result, and an automatic lengthening result;
a line matching sub-subunit, configured to: acquire a character display range of a line according to a width of a line area that is acquired by parsing and a typesetting width of characters in the line within the line area; and if a punctuation mark is arranged at the tail of the current line, according to an actual language of the punctuation mark, search in the typesetting RS for a corresponding typesetting rule;
a line setting sub-subunit, configured to: if a typesetting rule matching the punctuation mark is searched, process according to the punctuation forbidden property of the typesetting rule, remove a line tail-forbidden punctuation mark out of the character display range, and leave a line head-forbidden punctuation mark within the character display range; if a word is arranged at the tail of the current line, according to an actual language of the word, search in the typesetting RS for a corresponding typesetting rule; if a typesetting rule matching the word is searched, process according to the word break property in the typesetting rule, automatically insert a hyphen, leave letters before the hyphen within the character display range, and record a word break result; if a total character display width of the current line is smaller than the width of the line area, and no line stop character is arranged, traverse each of words in the current line, according to an actual language of the word, search in the typesetting RS for a corresponding typesetting rule; if a typesetting rule matching the words is searched, process according to automatic lengthening in the typesetting rule, automatically insert a lengthening character, lengthen the width of the word such that the total character display width of the current line is equal to the width of the line area, and record an automatic lengthening result; and
a line constructing sub-subunit, configured to acquire the render data information for the current line, and continue to construct the render data information for a next line until all lines are processed.

According to the method and apparatus for mixedly typesetting multi-language text provided in the embodiments of the present invention, a typesetting RS, an ML, an MF, and corresponding selected text is automatically acquired; and language parsing is performed according to the selected text and the corresponding typesetting RS, ML, and MF, and typesetting the selected text, and the selected text is typeset. In this way, the process of mixedly typesetting multi-language text is convenient and efficiently, and furthermore, workload of typesetting personnel can be greatly reduced, thereby reducing typesetting error rate.

Persons of ordinary skill in the art may understand that all or part of the steps of the methods in the embodiments may be implemented by a program instructing relevant hardware. The program may be stored in a computer readable storage medium. When the program runs, the steps of the methods in the embodiments are performed. The storage medium may be any media capable of storing program codes, such as ROM, RAM, a magnetic disk, or an optical disk.

The above embodiments are used only for illustrating the present invention, but are not intended to limit the protection scope of the present invention. Various modifications and replacements readily derived by those skilled in the art within technical disclosure of the present invention shall fail within the protection scope of the present invention. Therefore, the protection scope of the present invention is subject to the claims.

What is claimed is:

1. A method for mixedly typesetting multi-language text, comprising:
acquiring a typesetting rule set (RS), a multi-language (ML), a multi-font (MF), and a corresponding selected text; and
performing language parsing according to the selected text and the corresponding typesetting RS, ML, and MF, and typesetting the selected text.

2. The method for mixedly typesetting multi-language text according to claim 1, further comprising:
creating the typesetting RS, ML, and MF;
wherein the typesetting RS comprises: a language property, a punctuation forbidden property, and a word break property, an automatic lengthening property, a vertical text rotation property; the ML, comprises a primary language property and a N number of secondary language properties, N≧1; and the ML comprises at least one font item, wherein the font item comprises a language property and a font property.

3. The method for mixedly typesetting multi-language text according to claim 1, wherein the performing language parsing according to the selected text and the corresponding typesetting RS, ML, and MF, and typesetting the selected text specifically comprises:
performing, language parsing on characters in the selected text one by one, and constructing render data typesetting for the characters;
searching for a corresponding typesetting RS according to an actual language of the parsed characters; and
typesetting lines in the selected text one by one according to the typesetting RS, and constructing render data typesetting for the lines,

4. The method for mixedly typesetting multi-language text according to claim 3, wherein the performing language parsing on characters in the selected text one by one, and constructing render data typesetting for the characters specifically comprises:
parsing a current character, and constructing render data information for the current character, wherein the render data information of the current character comprises; an actual language, a display font, and a rotation angle;
matching a language property L and a character code that are acquired by parsing with the ML, and setting a language property successfully matching the ML as the actual language of the current character;
searching in the MF for a corresponding font property according to the actual language of the current character, and setting a font property successfully matching the MF as the display font in a render data font information of the current character;
when vertical typesetting is set for the current character, searching in the typesetting RS for a corresponding typesetting rule according to the actual language of the current character, and setting a vertical text rotation angle successfully matching the typesetting rule in the typesetting RS as the rotation angle in the render data font information of the current character; and
acquiring the render data information of the current character, and continuing to construct the render data information for a next character until all characters are processed.

5. The method for mixedly typesetting multi-language text according to claim 4, wherein the matching a language property L and a character code that are acquired by parsing with the ML, and setting a language property successfully matching the ML as the actual language of the current character specifically comprises:
acquiring an ML corresponding to the current character according to the language property L and the character code that are acquired by parsing;
judging, according to a primary language and a code interval thereof in the ML, whether the character code of the current character is within the code interval; if the character code is within the code interval, setting the actual language of the current character as the primary language, and exiting the process; and otherwise, proceeding to a next step;
traversing secondary languages in the ML one by one, and judging, according to a code interval of the secondary language, whether the character code of the current character is within the code interval; if the character code is within the code interval of the secondary language, setting the actual language of the current character as the secondary language, and exiting the process; and otherwise, proceeding to a next step; and
setting the actual language of the current character as the primary language.

6. The method for mixedly typesetting multi-language text according to claim 5, wherein the typesetting lines in the selected text one by one according to the typesetting RS, and constructing render data typesetting for the lines specifically comprises:
performing language parsing on lines in the selected text one by one, and constructing render data information for a current line, wherein the render data information of the current line comprises: a character display range, a word break result, and an automatic lengthening result;
acquiring a character display range of a line according to a width of a line area that is acquired by parsing and a typesetting width between characters in the line within the line area;
if a punctuation mark is arranged at the tail of the current line, according to an actual language of the punctuation mark, searching in the typesetting RS for a corresponding typesetting rule; if a typesetting rule matching the punctuation mark is searched, processing the current line according to the punctuation forbidden property of the typesetting rule, removing a line tail-forbidden punctuation mark out of the character display range, and leaving a line head-forbidden punctuation mark within the character display range;
if a word is arranged at the tail of the current line, according to an actual language of the word, searching in the typesetting RS for a corresponding typesetting rule; if a typesetting rule matching the word is searched, processing the current line according to the typesetting rule, automatically inserting a hyphen, leaving letters before the hyphen within the character display range, and recording a word break result;
if a total character display width of the current line is smaller than the width of the line area, and no line stop character is arranged, traversing ail words in the current line, according to an actual language of each of the words, searching in the typesetting RS for a corresponding typesetting rule; if a typesetting ride matching the word is searched, according to automatic lengthening in the typesetting rule, automatically inserting a lengthening character, lengthening the width of the word such that the total character display width of the current line is equal to the width of the line area, and recording an automatic lengthening result; and
acquiring the render data information of the current line, and continuing to construct the render data information for a next line until all lines are processed.

7. An apparatus for mixedly typesetting multilingual text, comprising:
an information acquiring unit, configured to acquire a typesetting rule set (RS), a multi-language (ML), a multi-font (MF), and corresponding selected text; and
a typesetting unit, configured to perform language parsing according to the selected text and the corresponding typesetting RS, ML, and MF, and typeset the selected text,

8. The apparatus for mixedly typesetting multi-language text according to claim 7, further comprising:
a rule creating unit, configured to create the typesetting RS, ML, and MF;
wherein the typesetting RS comprises: a language property, a punctuation forbidden property, and a word break property, an automatic lengthening property, a vertical text rotation property; the ML comprises a primary language property and a N number of secondary language properties, N≧1; and the MF comprises at least one font item, wherein the font item comprises a language property and a font property.

9. The apparatus for mixedly typesetting multi-language text according to claim 7, wherein the typesetting unit specifically comprises:
a character parsing subunit, configured to perform language parsing on characters in the selected text one by one, and construct render data typesetting for the characters;
a searching subunit, configured to search for a corresponding typesetting RS according to an actual language of the parsed characters; and
a line typesetting subunit, configured to typeset lines in the selected text one by one according to the typesetting RS, and construct render data typesetting for the lines.

10. The apparatus for mixedly typesetting multi-language text according to claim 9, wherein the character parsing subunit specifically comprises:
a character parsing sub-subunit, configured to parse a current character, and construct render data information for the current character, wherein the render data information of the current character comprises: an actual language, a display font, and a rotation angle;
a character matching sub-subunit, configured to match a language property L and a character code that are acquired by parsing with the ML, and set a language property successfully matching the ML to the actual language of the current character;
a character setting rib-subunit, configured to: search in the MF for a corresponding font property according to the actual language of the current character, and set a font property successfully matching the MF as the display font in a render data font information of the current character; when vertical typesetting is set for the current character, search in the typesetting RS for a corresponding typesetting rule according to the actual language of the current character, and set a vertical text rotation angle successfully matching the typesetting rule in the typesetting RS as the rotation angle in the render data font information of the current character; and
a character constructing sub-subunit, configured to acquire the render data information for the current character, and continue to construct the render data information for a next character until all characters are processed.

11. The apparatus for mixedly typesetting multi-language text according to claim 10, wherein the matching sub-subunit is specifically configured to:
acquire an ML corresponding to the current character according to the language property L and the character code that are acquired by parsing;
judge, according to a primary language and a code interval thereof in the ML, whether the character code of the current character is within the code interval; if the character code is within the code interval, set the actual language of the current character as the primary language, and exit the process; and otherwise, proceed to a next step;
traverse secondary languages in the ML one by one, and judge, according to a code interval of the secondary language, whether the character code of the current character is within the code interval; if the character code is within the code interval of the secondary language, set the actual language of the current character as the secondary language, and exit the process; and otherwise, proceed to a next step; and
set the actual language of the current character as the primary language.

12. The apparatus for mixedly typesetting multi-language text according to claim 11, wherein the line typesetting subunit specifically comprises:
a line parsing sub-subunit, configured to perform language parsing on lines in the selected text one by one, and construct render data information for a current line, wherein the render data information of the current line comprises: a character display range, a word break result, and an automatic lengthening result;
a line matching sub-subunit, configured to: acquire a character display range of a line according to a width of a line area that is acquired by parsing and a typesetting width of characters in the line within the line area; and if a punctuation mark is arranged at the tail of the current line, according to an actual language of the punctuation mark, search in the typesetting RS for a corresponding typesetting rule;
a line setting sub-subunit, configured to: if a typesetting rule matching the punctuation mark is searched, process according to the punctuation forbidden property of the typesetting rule, remove a line tail-forbidden punctuation mark out of the character display range, and leave a line head-forbidden punctuation mark within the character display range; if a word is arranged at the tail of the current line, according to an actual language of the word, search in the typesetting RS for a corresponding typesetting rule; if a typesetting rule matching the word is searched, process according to the word break property in the typesetting rule, automatically insert a hyphen, leave letters before the hyphen within the character display range, and record a word break result; if a total character display width of the current line is smaller than the width of the line area, and no line stop character is arranged, traverse each of words in the current line, according to an actual language of the word, search in the typesetting RS for a corresponding typesetting rule; if a typesetting rule matching the words is searched, process according to automatic lengthening in the typesetting rule, automatically insert a lengthening character, lengthen the width of the word such that the total character display width of the current line is equal to the width of the line area, and record an automatic lengthening result; and
a line, constructing sub-subunit, configured to acquire the render data information for the current line, and continue to construct the render data information for a next line until all lines are processed.

13. A non-transient storage medium storing a program configured to implement a method for mixedly typesetting multi-language text, wherein the storage medium enables a computer to invoke the program stored in the non-transient storage medium to perform the following steps:
acquiring a typesetting rule set (RS), a multi-language (ML), a multi-font (MF), and corresponding selected text; and
performing language parsing according to the selected text and the corresponding typesetting RS, ML, and MF, and typesetting the selected text.

14. The non-transient storage medium according to claim 13, wherein the storage medium enables the computer to invoke the program stored in the non-transient storage medium to further perform the following step:
creating the typesetting RS, ML, and MF;
wherein the typesetting RS comprises: a language property, a punctuation forbidden property, and a word break property, an automatic lengthening property, a vertical text rotation property; the ML comprises a primary language property and a N number of secondary language properties, N≧1; and the MF comprises at least one font item, wherein the font item comprises a language property and a font property,

15. The non-transient storage medium according to claim 13, wherein the performing language parsing according to the selected text and the corresponding typesetting RS, ML, and MF, and typesetting the selected text specifically comprises:
performing language parsing on characters in the selected text one by one, and constructing render data typesetting for the characters;
searching for a corresponding typesetting RS according to an actual language of the parsed characters; and
typesetting lines in the selected text one by one according, to the typesetting RS, and constructing render data typesetting for the lines.

16. The non-transient storage medium according to claim 15, wherein the performing language parsing on characters in the selected text one by one, and constructing render data typesetting for the characters specifically comprises:
parsing a current character, and constructing render data information for the current character, wherein the render data information of the current character comprises: an actual language, a display font, and a rotation angle;
matching a language property L and a character code that are acquired by parsing with the ML, and setting a language property successfully matching the ML as the actual language of the current character;
searching in the MF for a corresponding font property according to the actual language of the current character, and setting a font property successfully matching the MF as the display font in a render data font information of the current character;
when vertical typesetting is set liar the current character, searching in the typesetting RS for a corresponding typesetting rule according to the actual language of the current character, and setting a vertical text rotation angle successfully matching the typesetting rule in the typesetting RS as the rotation angle in the render data font information of the current character; and
acquiring the render data information of the current character, and continuing to construct render data information for a next character until all characters are processed.

17. The non-transient storage medium according to claim 16, wherein the matching a language property L and a character code that are acquired by parsing with the ML and setting a language property successfully matching the ML as the actual language of the current character specifically comprises:
acquiring an ML corresponding to the current character according to the language property L and the character code that are acquired by parsing;
judging, according to a primary language and a code interval thereof in the ML, whether the character code of the current character is within the code interval: if the character code is within the code interval, setting the actual language of the current character as the primary language, and exiting the process; and otherwise, proceeding to a next step:
traversing secondary languages in the ML one by one, and judging, according to a code interval of the secondary language, whether the character code of the current character is within the code interval; if the character code is within the code interval of the secondary language, set the actual language of the current character as the secondary language, and exiting the process; and otherwise, proceeding to a next step; and
setting the actual language of the current character as the primary language.

18. The non-transient storage medium according to claim 17, wherein the typesetting lines in the selected text one by one according to the typesetting RS, and constructing render data typesetting for the lines specifically comprises:
performing language parsing on lines in the selected text one by one, and constructing render data information for a current line, wherein the render data information of the current line comprises: a character display range, a word break result, and an automatic lengthening result;
acquiring a character display range of a line according to a width of a line area that is acquired by parsing and a typesetting width between characters in the line within the line area;
if a punctuation mark is arranged at the tail of the current line, according to an actual language of the punctuation mark, searching in the typesetting RS for a corresponding typesetting rule; if a typesetting rule matching the punctuation mark is searched, processing according to the punctuation forbidden property of the typesetting rule, removing a line tail-forbidden punctuation mark out of the character display range, and leaving a line head-forbidden punctuation mark within the character display range;
if a word is arranged at the tail of the current line, according to an actual language of the word, searching in the typesetting RS for a corresponding typesetting rule; if a typesetting rule matching the word is searched, processing according to the typesetting rule, automatically inserting a hyphen, leaving letters before the hyphen within the character display range, and recording a word break result;
if a total character display width of the current line is smaller than the width of the line area, and no line stop character is arranged, traversing all words in the current line, according to an actual language of each of the words, searching in the typesetting RS for a corresponding typesetting rule; if a typesetting mute matching the word is searched, according to automatic lengthening in the typesetting rule, automatically inserting a lengthening character, lengthening the width of the word such that the total character display width of the current line is equal to the width of the line area, and recording an automatic lengthening result; and
acquiring the render data information of the current line, and continuing to construct the render data information for a next line until all lines are processed.
